(19) United States
(12) Patent Application Publication
(10) Pub. No.: US 2026/0106162 A1
(43) Pub. Date: Apr. 16, 2026

(54) ELECTRODE ACTIVE MATERIAL, SLURRY FOR FORMING ELECTRODE MIXTURE LAYER INCLUDING THE SAME, AND ELECTRODE FORMED USING THE SAME

(71) Applicant: SK ON CO., LTD., Seoul (KR)

(72) Inventors: So Hyun PARK, Daejeon (KR); Hyeon A KIM, Daejeon (KR)

(21) Appl. No.: 19/331,955

(22) Filed: Sep. 17, 2025

(30) Foreign Application Priority Data
Oct. 14, 2024 (KR) 10-2024-0139140

(51) Int. Cl. H01M 4/62; H01M 4/36; H01M 4/587

(52) U.S. Cl. CPC H01M 4/628; H01M 4/366; H01M 4/587

(57) ABSTRACT

Provided are an electrode active material including core-shell particles including a core including carbonaceous particles and a shell surrounding at least a part of a surface of the core, wherein the shell includes a metal salt, a slurry for forming an electrode mixture layer including the material, an electrode including the electrode mixture layer formed therefrom, and an electrochemical device including the electrode.

### CROSS-REFERENCE TO RELATED APPLICATIONS

This application claims priority under 35 U.S.C. § 119 to Korean Patent Application No. 10-2024-0139140, filed on Oct. 14, 2024, in the Korean Intellectual Property Office, the disclosure of which is incorporated herein by reference in its entirety.

### TECHNICAL FIELD

The following disclosure relates to an electrode active material, a slurry for forming an electrode mixture layer including the same, and an electrode formed using the same.

### BACKGROUND

In recent years, as the application fields using electricity such as smartphones, camcorders, laptops, and electric vehicles expand, interest in an electrical storage device using an electrochemical device is growing, and in particular, among various electrochemical devices, a secondary battery, which may be charged and discharged, has high operation voltage, and has significantly high energy density, is in the spotlight.

In addition, as interest in environmental problems is growing, demand for electric vehicles, hybrid electric vehicle, and the like which may replace vehicles using fossil fuels such as gasoline vehicles and diesel vehicles as one of the main causes of air pollution expands, the market for devices employing high-capacity batteries is growing. In order to use as a power source of a device with the high-capacity battery, high-capacity electrode for manufacturing a secondary battery having high energy density, high output, and high discharge voltage is required to be designed.

### SUMMARY

An embodiment of the present disclosure is directed to providing an electrode active material for manufacturing an electrode which may implement long width and/or high loading.

Another embodiment of the present disclosure is directed to providing a slurry for forming an electrode mixture layer including the electrode active material according to the embodiment.

Another embodiment of the present disclosure is directed to providing an electrode including an electrode mixture layer formed from the slurry for forming an electrode mixture layer according to the embodiment, and an electrochemical device including the same.

Still another embodiment of the present disclosure is directed to providing an electrode with long width and high loading implemented, and an electrochemical device including the same.

In one general aspect, an electrode active material includes core-shell particles including a core including carbonaceous particles and a shell surrounding at least a part of the surface of the core, wherein the shell includes a metal salt.

In an exemplary embodiment, the metal salt may be included at 5.0 wt % or less with respect to the total weight of the carbonaceous particles and the metal salt.

In an exemplary embodiment, a content of a metal element in the metal salt measured by an inductively-coupled plasma (ICP) emission spectrometer may be 10 ppm to 5,000 ppm.

In an exemplary embodiment, the carbonaceous particles may include any one or more selected from the group consisting of artificial graphite, natural graphite, soft carbon, carbon black, acetylene black, ketjen black, carbon fiber, and mesocarbon microbeads (MCMB).

In an exemplary embodiment, the metal salt may include any one or more selected from the group consisting of an aluminum salt, a lithium salt, a lanthanum salt, a sodium salt, a potassium salt, a calcium salt, a magnesium salt, a copper salt, a silver salt, a gold salt, a zinc salt, a platinum salt, a nickel salt, an iron salt, a tin salt, a lead salt, a cobalt salt, a chromium salt, a molybdenum salt, a vanadium salt, a thallium salt, and a niobium salt.

In another general aspect, a slurry for forming an electrode mixture layer includes the electrode active material according to the embodiment.

In an exemplary embodiment, the slurry for forming an electrode mixture layer may further include any one or more of a conductive material, a thickener, and a dispersant.

In another general aspect, an electrode includes: a current collector, and an electrode mixture layer which is placed on the current collector and formed from the slurry for forming an electrode mixture layer according to the embodiment.

In an exemplary embodiment, the electrode mixture layer may include a binder, wherein the binder is included at 0.5 wt % to 5.0 wt % based on the total weight of the electrode mixture layer.

In another general aspect, an electrochemical device includes the electrode according to the embodiment.

In still another general aspect, an electrochemical device includes an electrode including a current collector, and an electrode mixture layer placed on the current collector, wherein the electrode has a coating width of 200 mm or more and a loading amount of 12 mg/cm² or more, and adhesive strength between the current collector and the electrode mixture layer is 0.3 N or more.

Other features and aspects will be apparent from the following detailed description, the drawings, and the claims.

### BRIEF DESCRIPTION OF THE DRAWINGS

FIG. 1 is a schematic plan view of the secondary battery according to an exemplary embodiment.

FIG. 2 is a schematic cross-sectional view of the secondary battery according to an exemplary embodiment.

### DETAILED DESCRIPTION OF MAIN ELEMENTS

100: Positive electrode
105: Positive electrode current collector
107: Positive electrode lead
110: Positive electrode mixture layer
120: Negative electrode mixture layer
125: Negative electrode current collector
127: Negative electrode lead
130: Negative electrode
140: Separator
150: Electrode assembly
160: Case

### DETAILED DESCRIPTION OF EMBODIMENTS

Since the embodiments described in the present specification may be modified in many different forms, the technology according to an exemplary embodiment is not limited to the embodiments set forth herein. Furthermore, throughout the specification, unless otherwise particularly stated, the word “comprising”, “including”, “containing”, “being provided with”, or “having” does not mean the exclusion of any other constituent element, but rather means further inclusion of other constituent elements, and elements, materials, or processes which are not further listed are not excluded.

The numerical range used in the present specification includes all values within the range including the lower limit and the upper limit, increments logically derived from the form and breadth of a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present specification. Unless otherwise defined in the present specification, values which may be outside a numerical range due to experimental error or rounding off of a value are also included in the defined numerical range.

Hereinafter, unless otherwise particularly defined in the present specification, “about” may be considered as a value within 30%, 25%, 20%, 15%, 10%, 5%, 3%, 2%, 1%, or 0.5% of a stated value.

Hereinafter, in the present specification, “width” is a width in the direction perpendicular to the direction of electrode traveling during manufacture of an electrode and refers to a direction of the side of a current collector on which a slurry for forming an electrode mixture layer is not applied based on the center of a mixture layer formed by applying the slurry.

Hereinafter, the present disclosure will be described in detail (with reference to the accompanying drawings). However, it is only illustrative and the present disclosure is not limited to the specific embodiments which are illustratively described in the present disclosure.

In order to implement high energy density, high output, and high discharge voltage of a battery, the loading amount of an electrode is required to be increased. However, when the electrode is manufactured with a long width and/or a high loading, it is difficult to uniformly coat a slurry for forming an electrode mixture layer (slurry for a negative electrode material and/or a positive electrode material) on a current collector, or when the electrode is exposed to strong winds and high temperatures in order to dry the high-loading electrode, the electrode is dried to greatly increase a probability of cracks occurring, which may be a cause of reducing long-term performance of the battery.

As a method for solving the problems of the high-loading electrode, the content of a binder may be increased for improving binding strength between active materials, but when the binder content in the slurry for forming an electrode mixture layer is higher than a predetermined level, electrode resistance is increased, and deterioration of fast charging performance may be shown.

Regarding this, in an implementation example, the binding strength between an active material and a binder is strengthened by coating at least a part of the surface of the active material with a hydrophilic metal salt, and simultaneously a high-quality electrode of ultrahigh loading and/or long width was implemented.

Specifically, an exemplary embodiment provides an electrode active material including core-shell particles including a core including carbonaceous particles and a shell surrounding at least a part of the surface of the core, wherein the shell includes a metal salt.

In an exemplary embodiment, the metal salt may be included at 5.0 wt % or less, 4.0 wt % or less, 3.5 wt % or less, 3.2 wt % or less, 3.0 wt % or less, 2.0 wt % or less, 1.5 wt % or less, 1.0 wt % or less, 0.5 wt % or less, 0.3 wt % or less, or 0.2 wt % or less, with respect to the total weight of the carbonaceous particles and metal salt, and the lower limit herein may be more than 0 wt %, 0.01 wt % or more, 0.03 wt % or more, or 0.05 wt % or more. In an exemplary embodiment, within the above content range of the metal salt, mixing with carbonaceous particles is uniformly performed, so that core-shell particles are easily formed, and the shell having a uniform thickness may be formed. Otherwise, within the above content range of the metal element, high binding strength with a binder and/or formation of a high-loading electrode is/are allowed. In an exemplary embodiment, the shell is formed by dissolving the aqueous metal salt in an aqueous solvent to make a salt state, and then adsorbing it onto carbonaceous particles, and may be formed on at least a part of the surface of the core. Herein, without being bound to a specific theory, the average thickness of the shell may be 10 nm to 100 nm, 10 nm to 80 nm, 10 nm to 60 nm, or 30 nm to 60 nm. In an exemplary embodiment, within the thickness range, improved conductivity of a battery and electrode adhesive strength may be implemented. The average thickness may be calculated as an average value of thicknesses measured at 10 random points of the shell, or may be calculated as a median value of the largest value and the smallest value of the thicknesses measured at 10 points. In addition, the thickness value may be measured using a transmission electron microscope (TEM) or scanning electron microscope (SEM).

In an exemplary embodiment, the content of a metal element in the metal salt measured by an inductively-coupled plasma (ICP) emission spectrometer may be 10 ppm to 5,000 ppm, 10 ppm to 4,000 ppm, 10 ppm to 3,800 ppm, 10 ppm to 3,000 ppm, 10 ppm to 2,500 ppm, 10 ppm to 2,000 ppm, 10 ppm to 1,000 ppm, 10 ppm to 900 ppm, or 10 ppm to 800 ppm. The content of the metal element measured by the inductively-coupled plasma emission spectrometer has a correlation with the content of the metal salt. In an exemplary embodiment, mixing with carbonaceous particles is uniformly performed within the content range of the metal element, so that core-shell particles are easily formed, and the shell having a uniform thickness may be formed. Otherwise, within the above content range of the metal element, high binding strength with a binder and/or formation of a high-loading electrode is/are allowed.

In an exemplary embodiment, the average particle diameter (D50) of the carbonaceous particles may be 1 μm to 30 μm, 3 μm to 25 μm, 5 μm to 25 μm, 5 μm to 20 μm, 5 μm to 15 μm, or 10 μm to 20 μm. Without being bound to a specific theory, when the average particle diameter of the carbonaceous particles satisfies the above range, a uniform core may be formed, or a long width and high-loading electrode on an electrode thin film may be easily implemented through uniform coating.

In an exemplary embodiment, though being not particularly limited, the carbonaceous particles may include any one or more selected from the group consisting of, for example, artificial graphite, natural graphite, soft carbon, carbon black, acetylene black, ketjen black, carbon fiber, and mesocarbon microbeads (MCMB). In an exemplary embodiment, the carbonaceous particles may include any one or more of artificial graphite and natural graphite, and specifically, as the carbonaceous particles, any one of artificial graphite or natural graphite may be used alone, or a mixture of artificial graphite and natural graphite may be used. In an exemplary embodiment, when a mixture of artificial graphite and natural graphite is used as the carbonaceous particles, their weight ratio may be, for example, 1:9 to 9:1, 2:8 to 8:2, 3:7 to 7:3, 4:6 to 6:4, or 5:5. Without being bound to a specific theory, in the case of using the mixture of artificial graphite and natural graphite as the carbonaceous particles, when the mixing is performed within the range, the binding strength with a binder may be implemented without using a crosslinking agent and/or a binder at a high content.

Meanwhile, since artificial graphite single particles are usually fine particles and have a high specific surface area, when they are used alone as an electrode active material, the crosslinking agent is further required as compared with other carbonaceous particles, and thus, cracks are highly likely to occur during electrode drying. However, the electrode active material according to an exemplary embodiment may strengthen binding strength between an active material and a binder without using a high content of the binder, even when being used alone without mixing artificial graphite with natural graphite.

In an exemplary embodiment, the carbonaceous particle may be secondary particle formed by agglomeration of two or more primary particles, in which the primary particle may be plate-shaped, and the secondary particle may be flake-shaped.

In an exemplary embodiment, the metal salt may be hydrophilic and be a metal organic salt or a metal inorganic slat. Specifically, for example, the metal salt may include any one or more selected from the group consisting of an aluminum (Al) salt, a lithium (Li) salt, a lanthanum (La) salt, a sodium (Na) salt, a potassium (K) salt, a calcium

(Ca) salt, a magnesium (Mg) salt, a copper (Cu) salt, a silver (Ag) salt, a gold (Au) salt, a zinc (Zn) salt, a platinum (Pt) salt, a nickel (Li) salt, an iron (Fe) salt, a tin (Sn) salt, a lead (Pb) salt, a cobalt (Co) salt, a chromium (Cr) salt, a molybdenum (Mo) salt, a vanadium (V) salt, a thallium (Ti) salt, and a niobium (Nb) salt.

More specifically, the metal salt may be Al₂(SO₄)₃, Al₂(SO₃)₃, Al(H₂PO₃)₃, Al(NO₃)₃, Al(CHCOO₃)OH, Al(OH)₃, AlCl₃, AlK(SO₄)₂, Al(HSO₄)₃;
Cu(NO₃)₂, Cu(HCOO)₂, CuCl₂, CuCN, Cu(CH₃COO)₂, CuSO₄;
LiPF₆, LiBF₄, Li[FSI], Li[TFSI], Li[f3C], Li[BOB], LiClO₄, LiBF₃(CF₃), LiBF₃(C₂F₅), LiBF₃(C₃F₇), LiBF₃(C₄F₉), LiC(SO₂CF₃)₃, CF₃SO₂OLi, CF₃COOLi, R′COOLi (R′ is an alkyl group having 1 to 10 carbon atoms, a phenyl group, or a naphthyl group);
NaPF₆, NaBF₄, Na[FSI], Na[TFSI], Na[f3C], Na[BOB], NaClO₄, NaBF₃(CF₃), NaBF₃(C₂F₅), NaBF₃(C₃F₇), NaBF₃(C₄F₉), NaC(SO₂CF₃)₃, CF₃SO₂ONa, CF₃COONa, R′COONa (R′ is an alkyl group having 1 to 10 carbon atoms, a phenyl group, or a naphthyl group);
Ca(PF₆)₂, Ca(BF₄)₂, Ca[FSI]₂, Ca[TFSI]₂, Ca[f3C]₂, Ca[BOB]₂, Ca(ClO₄)₂, Ca[BF₃(CF₃)]₂, Ca[BF₃(C₂F₅)]₂, Ca[BF₃(C₃F₇)]₂, Ca[BF₃(C₄F₉)]₂, Ca[C(SO₂CF₃)₃]₂, (CF₃SO₂O)₂Ca, (CF₃COO)₂Ca, (R′COO)₂Ca (R′ is an alkyl group having 1 to 10 carbon atoms, a phenyl group, or a naphthyl group);
Mg(PF₆)₂, Mg(BF₄)₂, Mg[FSI]₂, Mg[TFSI]₂, Mg[f3C]₂, Mg[BOB]₂, Na(ClO₄)₂, Mg[BF₃(CF₃)]₂, Mg[BF₃(C₂F₅)]₂, Mg[BF₃(C₃F₇)]₂, Mg[BF₃(C₄F₉)]₂, Mg[C(SO₂CF₃)₃]₂, (CF₃SO₃)₂Mg, (CF₃COO)₂Mg, (R′COO)₂Mg (R′ is an alkyl group having 1 to 10 carbon atoms, a phenyl group, or a naphthyl group);
Zn(NO₃)₂, ZnSO₄, ZnC₂O₄, Zn(CH₃CO₂)₂;
Ni(NO₃)₂, Ni(CH₃CO₂)₂, Ni(C₅H₈O₂), NiF₂, NiCl₂, NiSO₄; or K₂CO₃, or may be a hydrate (for example, Al₂(SO₄)₃·4-18H₂0, Al(NO₃)₃·9H₂O, CuSO₄·5H₂O, Cu(CH₃COO)₂·H₂O, CuCl₂·H₂O, ZnC₂O₄·2H₂O, Zn(CH₃CO₂)₂·2H₂O, Ni(NO₃)₂·2H₂O, Ni(NO₃)₂·4H₂O, Ni(NO₃)₂·6H₂O, Ni(CH₃CO₂)₂·2H₂O, Ni(CH₃CO₂)₂·4H₂O, Ni(C₅H₈O₂)·2 2H₂O, or NiCl₂·6H₂O).

Specifically, the metal salt according to an exemplary embodiment may be an aluminum salt, and may be, for example, Al(NO₃)₃, Al(OH)₃, Al₂(SO₄)₃, or a hydrate thereof. Without being bound to a specific theory, since an aluminum salt has binding strength with a known binder and easily forms a uniform shell on the core including the carbonaceous particles, the metal salt included in the shell may include an aluminum salt.

In an exemplary embodiment, the electrode active material may be a negative electrode active material.

Another implementation example provides a slurry for forming an electrode mixture layer (slurry for forming an electrode material (negative electrode material) including the electrode active material of the exemplary embodiment.

In an exemplary embodiment, the slurry for forming an electrode mixture layer may further include a binder. In an exemplary embodiment, the binder may be a binder which may be physically/chemically bound to the hydrophilic metal salt formed on the shell of the electrode active material, and may be, for example, a hydrophilic binder. In an exemplary embodiment, the electrode active material strengthens the binding strength with the hydrophilic binder, by coating at least a part of the surface of hydrophobic carbonaceous particles, and thus, prevents cracks of an electrode and improves electrode adhesive strength without using a high content of binder.

In an exemplary embodiment, the binder or hydrophilic binder may be used without limitation as long as it is well known to a person with ordinary skill in the art disclosed in the present specification, and may be, for example, a hydrophilic binder including any one or two or more polar groups selected from the group consisting of a hydroxyl group, a carboxyl group, an anhydrous maleic acid group, a sulfonic acid group, and an isocyanate group. Specifically, the binder may include a styrene butadiene copolymer (e.g., styrene-butadiene rubber (SBR)), polyvinylidene fluoride, cyanoethyl pullulan, cyanoethyl polyvinyl alcohol, cyanoethyl cellulose, cyanoethyl sucrose, carboxyl methyl cellulose, polyvinylalcohol, polyacrylic acid, polymaleic anhydride, or polyvinylpyrrolidone.

In an exemplary embodiment, the slurry for forming an electrode mixture layer may further include any one or more of a conductive material, a thickener, and a dispersant.

In an exemplary embodiment, the slurry for forming an electrode mixture layer may be a slurry for forming a negative electrode mixture layer.

Another implementation example provides an electrode including a current collector and an electrode mixture layer which is placed on the current collector and includes an electrode mixture layer formed from the slurry for forming an electrode mixture layer according to the exemplary embodiment.

In an exemplary embodiment, the electrode mixture layer may include a binder, and the description of the binder will be omitted, since it overlaps the above description of the binder included in the slurry for forming an electrode mixture layer. The binder may be included at 0.5 wt % to 5.0 wt %, 0.5 wt % to 4.0 wt %, 0.5 wt % to 3.0 wt %, 0.5 wt % to 2.0 wt %, 0.8 wt % to 2.0 wt %, 0.8 wt % to 1.8 wt %, 0.8 wt % to 1.5 wt %, 1.0 wt % to 1.5 wt %, or about 1.2 wt %. The electrode active material according to an exemplary embodiment excellently strengthens the binding strength with the binder as compared with the conventional electrode active material including only carbonaceous particles, by forming a shell including a metal salt on at least a part of the surface of the carbonaceous particles of the core. Thus, though the binder was conventionally used at a high content of more than 5 wt % for improving binding strength between the electrode active material and the binder, the binding strength between the electrode active material and the binder is strengthened without using a high content of the binder, thereby significantly lowering a crack occurrence risk during electrode drying, and simultaneously improving adhesive strength between the electrode mixture layer and the current collector. When the binder is used at more than 5 wt % or 10 wt % or more, crack occurs during electrode drying, resistance of the electrode is increased, and deterioration of fast charge may be shown, which is thus not effective. In an exemplary embodiment, the loading amount of the electrode may be 12 mg/cm² or more, 12.5 mg/cm² or more, 13.0 mg/cm² or more, 14.0 mg/cm² or more, 15.0 mg/cm² or more, 17.0 mg/cm² or more, or 19.0 mg/cm² or more, and the upper limit herein may be 25.0 mg/cm² or less, 23.0 mg/cm² or less, 21.0 mg/cm² or less, 20.0 mg/cm² or less, or 19.0 mg/cm² or less.

In an exemplary embodiment, the adhesive strength between the current collector and the electrode mixture layer may be 0.3 N or more, 0.4 N or more, 0.5 N or more, 0.6 N or more, or 0.8 N or more, and the upper limit herein may be 2.0 N or less, 1.8 N or less, 1.5 N or less, 1.3 N or less, 1.0 N or less, or 0.8 N or less. In an exemplary embodiment, the adhesive strength is peel strength measured using a VR300S model available from Hwain Automation.

In an exemplary embodiment, the electrode may have a specific surface area of 1.0 m²/g or more, 1.2 m²/g or more, 1.5 m²/g or more, 1.8 m²/g or more, or 2.0 m²/g or more, and the upper limit herein may be 3.0 m²/g or less, 2.8 m²/g or less, 2.6 m²/g or less, 2.5 m²/g or less, 2.3 m²/g or less, or 2.0 m²/g or less.

In an exemplary embodiment, the electrode may have a coating width of 200 mm or more, 220 mm or more, 250 mm or more, 260 mm or more, or 300 mm or more, and the upper limit herein may be 500 mm or less, 400 mm or less, 350 mm or less, or 300 mm or less.

In an exemplary embodiment, the electrode mixture layer may have a thickness of 50 μm to 150 μm, 80 μm to 150 μm, 80 μm to 130 μm, 100 μm to 150 μm, 100 μm to 130 μm, or 110 μm to 120 μm.

In an exemplary embodiment, the electrode may be a negative electrode.

Another implementation example provides an electrochemical device including the electrode according to the embodiment. In an exemplary embodiment, the electrochemical device may be, for example, a secondary battery, and specifically, a lithium secondary battery.

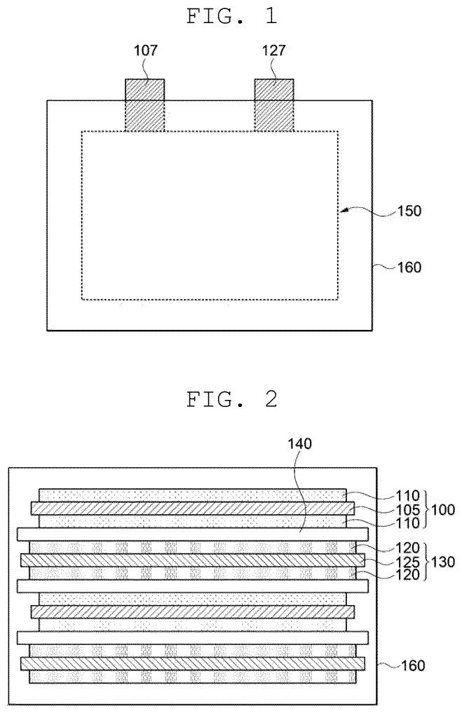

FIGS. 1 and 2 are a schematic plan view and a schematic cross-sectional view showing the secondary batteries according to exemplary embodiments, respectively.

Referring to FIGS. 1 and 2, the secondary battery may include a positive electrode 100 and a negative electrode 130 opposite to the positive electrode 100. The positive electrode 100 may include a positive electrode current collector 105 and a positive electrode mixture layer 110 on the positive electrode current collector 105. The positive mixture layer 110 may include a positive electrode active material, and if necessary, a positive electrode binder and a conductive material.

The positive electrode 100 may be manufactured by mixing a positive electrode active material, a positive electrode binder, a conductive material, a dispersion medium, and the like and performing stirring to prepare a slurry for forming a positive electrode mixture layer, and then applying the slurry on the positive electrode current collector 105 and performing drying and rolling.

The positive electrode current collector 105 may include, for example, stainless steel, nickel, aluminum, titanium, copper, or an alloy thereof, and more preferably, may include aluminum or an aluminum alloy.

In an exemplary embodiment, the secondary battery may be a lithium secondary battery, and for example, may be a lithium metal secondary battery, a lithium ion secondary battery, a lithium polymer secondary battery, a lithium ion polymer secondary battery, or the like.

Another implementation example provides an electrode including: a current collector and an electrode mixture layer placed on the current collector, wherein the electrode has a coating width of 200 mm or more and a loading amount of 12 mg/cm² or more, and adhesive strength between the current collector and the electrode mixture layer is 0.3 N or more.

In an exemplary embodiment, the loading amount of the electrode may be 12 mg/cm² or more, 12.5 mg/cm² or more, 13.0 mg/cm² or more, 14.0 mg/cm² or more, 15.0 mg/cm² or more, 17.0 mg/cm² or more, or 19.0 mg/cm² or more, and the upper limit herein may be 25.0 mg/cm² or less, 23.0 mg/cm² or less, 21.0 mg/cm² or less, 20.0 mg/cm² or less, or 19.0 mg/cm² or less.

In an exemplary embodiment, the adhesive strength between the current collector and the electrode mixture layer may be 0.3 N or more, 0.4 N or more, 0.5 N or more, 0.6 N or more, or 0.8 N or more, and the upper limit herein may be 2.0 N or less, 1.8 N or less, 1.5 N or less, 1.3 N or less, 1.0 N or less, or 0.8 N or less.

In an exemplary embodiment, the electrode may have a specific surface area of 1.0 m²/g or more, 1.2 m²/g or more, 1.5 m²/g or more, 1.8 m²/g or more, or 2.0 m²/g or more, and the upper limit herein may be 3.0 m²/g or less, 2.8 m²/g or less, 2.6 m²/g or less, 2.5 m²/g or less, 2.3 m²/g or less, or 2.0 m²/g or less.

In an exemplary embodiment, the electrode may have a coating width of 200 mm or more, 220 mm or more, 250 mm or more, 260 mm or more, or 300 mm or more, and the upper limit herein may be 500 mm or less, 400 mm or less, 350 mm or less, or 300 mm or less.

In an exemplary embodiment, the electrode mixture layer may have a thickness of 50 μm to 150 μm, 80 μm to 150 μm, 80 μm to 130 μm, 100 μm to 150 μm, 100 μm to 130 μm, or 110 μm to 120 μm.

### [Positive Electrode]

A positive electrode may include a positive electrode current collector and a positive electrode mixture layer placed on at least one surface of the positive electrode current collector.

### (Positive Electrode Current Collector)

The positive electrode current collector may include stainless steel, nickel, aluminum, titanium, or an alloy thereof. The positive electrode current collector may also include aluminum or stainless steel which is surface-treated with silver, carbon, nickel, or titanium. Though being not limited thereto, the positive electrode current collector may be, for example, 10 μm to 50 μm.

### (Positive Electrode Material)

A positive electrode mixture layer may include a positive electrode active material. The positive electrode active material may include a compound which may reversibly intercalate and deintercalate lithium ions.

According to exemplary embodiments, the positive electrode active material may include a lithium-nickel metal oxide. The lithium-nickel metal oxide may further include at least one of cobalt (Co), manganese (Mn), and aluminum (Al).

In some exemplary embodiments, the positive electrode active material or the lithium-nickel metal oxide may include a layered structure or a crystal structure represented by the following Chemical Formula 1:

LiₓNiₐM_{b}O_{2+z} [Chemical Formula 1]
wherein 0.9≤x≤1.2, 0.6≤a≤0.99, 0.01≤b≤0.4, and −0.5≤z≤0.1. As described above, M may include Co, Mn, and/or Al.

The chemical structure represented by Chemical Formula 1 shows a bonding relationship included in the layered structure or the crystal structure of the positive electrode active material, and it does not mean that other additional elements are excluded. For example, M includes Co and/or Mn, and Co and/or Mn may be provided as a main active element of the positive electrode active material with Ni. Chemical Formula 1 is provided for expressing the bonding relationship of the main active elements and should be understood as a formula covering introduction of an additional element and substitution.

In an exemplary embodiment, auxiliary elements which are added to the main active elements to enhance chemical stability of the positive electrode active material or the layered structure/crystal structure may be further included. The auxiliary element may be incorporated into the layered structure/crystal structure and form a bond, and in this case also, should be understood to be included in the range of the chemical structure represented by Chemical Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. The auxiliary element may act as, for example, an auxiliary active element which contributes to the capacity/output activity of the positive electrode active material with Co or Mn, like Al.

For example, the positive electrode active material or the lithium-nickel metal oxide may include a layered structure or a crystal structure represented by the following Chemical Formula 1-1:

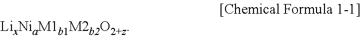

In Chemical Formula 1-1, M1 may include Co, Mn, and/or Al. M2 may include the auxiliary elements described above. In Chemical Formula 1-1, 0.9≤x≤1.2, 0.6≤a≤0.99, 0.01≤b1+b2≤0.4, and −0.5≤z≤0.1.

The positive electrode active material may further include a coating element or a doping element. For example, elements which are substantially identical or similar to the auxiliary elements described above may be used as a coating element or a doping element. For example, among the elements described above, a single element or a combination of two or more elements may be used as a coating element or a doping element.

The coating element or the doping element may be present on the surface of the lithium-nickel metal oxide particles or may penetrate through the surface of the lithium-nickel metal composite oxide particles and included in the combined structure represented by Chemical Formula 1 or Chemical Formula 1-1.

The positive electrode active material may include a nickel-cobalt-manganese (NCM)-based lithium oxide. In this case, an NCM-based lithium oxide having an increased nickel content may be used.

Ni may be provided as a transition metal related to the output and capacity of a lithium secondary battery. Therefore, as described above, since a high-content (high-Ni) composition is adopted into the positive electrode active material, a high-capacity positive electrode and a high-capacity lithium secondary battery may be provided.

However, as the content of Ni increases, the long-term preservation stability and the life stability of the positive electrode or the secondary battery may be relatively reduced, and a side reaction with an electrolyte may be increased. However, according to exemplary embodiments, the life stability and the capacity retention properties may be improved by Mn while maintaining the electrical conductivity by including Co.

The content of Ni in the NCM-based lithium oxide (for example, the mole fraction of nickel of the total moles of nickel, cobalt, and manganese) may be 0.6 or more, 0.7 or more, or 0.8 or more. In some exemplary embodiments, the content of Ni may be 0.8 to 0.95, 0.82 to 0.95, 0.83 to 0.95, 0.84 to 0.95, 0.85 to 0.95, or 0.88 to 0.95.

In some exemplary embodiments, the positive electrode active material may include a lithium cobalt oxide-based active material, a lithium manganese oxide-based active material, a lithium nickel oxide-based active material, or a lithium iron phosphate (LFP)-based active material (for example, LiFePO₄).

In some exemplary embodiments, the positive electrode active material may include a Mn-rich-based active material having a chemical structure or crystal structure represented by Chemical Formula 2, a Li rich layered oxide (LLO)/over lithiated oxide (OLO)-based active material, or a Co-less-based active material:

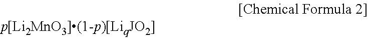

wherein 0<p<1 and 0.95≤q≤1.2, and J may include at least one element of Mn, Ni, Co, Fe, Cr, V, Cu, Zn, Ti, Al, Mg, and B.

### (Method for Manufacturing Positive Electrode)

For example, the positive electrode active material may be mixed into the solvent to prepare a positive electrode After coating the positive electrode current slurry.

collector with the positive electrode slurry, drying and rolling may be performed to manufacture a positive electrode mixture layer. The coating process may be performed by a method such as gravure coating, slot die coating, multilayer simultaneous die coating, imprinting, doctor blade coating, dip coating, bar coating, and casting, but is not limited thereto. The positive electrode mixture layer may further include a binder, and may optionally further include a conductive material, a thickener, and the like. Herein, the binder and the conductive material are as described above.

### (Positive Electrode Solvent)

A non-limiting example of the solvent used in the preparation of the positive electrode mixture may include N-methyl-2-pyrrolidone (NMP), dimethyl formamide, dimethyl acetamide, N, N-dimethylaminopropylamine, ethylene oxide, tetrahydrofuran, isobutyl isobutyrate, butyl butyrate, xylene, anisole, and the like.

### (Positive Electrode Binder)

The binder may include a non-water-based binder and/or a water-based binder, or rubber-based binder and/or fluorine-based binder, and for example, may include polyvinylidene fluoride (PVDF), poly(vinylidene fluoride-co-hexafluoropropylene (PVDF-HFP), polyacrylonitrile, polymethyl methacrylate, acrylonitrile butadiene rubber (NBR), polybutadiene rubber (BR), styrene-butadiene rubber (SBR), and the like. In an exemplary embodiment, a PVDF-based binder may be used as a positive electrode binder.

### (Positive Electrode Conductive Material)

The conductive material may be added for increasing conductivity of the positive electrode mixture layer and/or mobility of lithium ions or electrons. For example, the conductive material may be a linear conductive material and/or a dot-shaped conductive material, and for example, may include carbon-based conductive materials such as graphite, carbon black, acetylene black, ketjen black, graphene, carbon nanotubes, vapor-grown carbon fiber (VGCF), carbon fiber, and carbon nanofiber, and/or metal-based conductive materials including tin, tin oxide, titanium oxide, perovskite materials such as LaSrCoO₃ and LaSrMnO₃, and the like, but is not limited thereto.

### (Positive Electrode Thickener/Dispersant)

If necessary, the positive electrode mixture may further include a thickener and/or a dispersant and the like. As an exemplary embodiment, the positive electrode mixture may include a thickener such as carboxymethyl cellulose (CMC).

### [Negative Electrode]

The negative electrode may include a negative electrode current collector and a negative electrode mixture layer placed on at least one surface of the negative electrode current collector.

### (Negative Electrode Current Collector)

A non-limiting example of the negative electrode current collector may include a copper foil, a nickel foil, a stainless-steel foil, a titanium foil, a nickel foam, a copper foam, a polymer substrate coated with a conductive metal, and the like. The negative electrode current collector is not limited, but may be, for example, 10 to 50 μm.

### (Negative Electrode Material)

The negative electrode mixture layer may include a negative electrode active material. As the negative electrode active material, a material capable of adsorbing or desorbing lithium ions may be used. For example, the negative electrode active material may be a carbonaceous material such as crystalline carbon, amorphous carbon, carbon composite, and carbon fiber; lithium metal; lithium alloy; a silicon (Si)-containing material, a tin (Sn)-containing material, or the like.

An example of the amorphous carbon may include hard carbon, soft carbon, coke, mesocarbon microbead (MCMB), mesophase pitch-based carbon fiber (MPCF), and the like.

An example of the crystalline carbon may include graphite-based carbon such as natural graphite, artificial graphite, graphitized coke, graphitized MCMB, and graphitized MPCF.

The lithium metal may include a pure lithium metal or a lithium metal on which a protective layer for suppressing dendrite growth and the like is formed. In an exemplary embodiment, a lithium metal-containing layer which is deposited or coated on a negative electrode current collector may be used as a negative electrode mixture layer. In an exemplary embodiment, a lithium thin film layer may be used as a negative electrode mixture layer.

An element included in the lithium alloy may include aluminum, zinc, bismuth, cadmium, antimony, silicon, lead, tin, gallium, indium, or the like.

The silicon-containing material may provide more increased capacity characteristics. The silicon-containing material may include Si, SiOₓ (0<x<2), metal-doped SiOₓ (0<x<2), a silicon-carbon composite, and the like. The metal may include lithium and/or magnesium, and the metal-doped SiOₓ (0<x<2) may include metal silicate.

### (Method for Manufacturing Negative Electrode)

For example, the negative electrode active material may be mixed into the solvent to prepare a negative electrode slurry. After coating/depositing the negative electrode current collector with the negative electrode slurry, drying and rolling may be performed to manufacture a negative electrode mixture layer. The coating process may be performed by a method such as gravure coating, slot die coating, multilayer simultaneous die coating, imprinting, doctor blade coating, dip coating, bar coating, and casting, but is not limited thereto. The negative electrode mixture layer may further include a binder, and may optionally further include a conductive material, a thickener, and the like.

In some exemplary embodiments, the negative electrode may include a negative electrode mixture layer in a lithium metal form formed by a deposition/coating process.

### (Negative Electrode Solvent)

A non-limiting example of the solvent for a negative electrode mixture may include water, pure water, deionized water, distilled water, ethanol, isopropanol, methanol, acetone, n-propanol, t-butanol, isobutyl isobutyrate, butyl butyrate, xylene, anisole, and the like.

### (Negative Electrode Binder/Conductive Material/Thickener)

As the binder, the conductive material, and the thickener, the materials described above, which may be used in the manufacture of a positive electrode, may be used.

In some exemplary embodiments, rubber-based binder such as a styrene-butadiene rubber (SBR)-based binder, carboxymethyl cellulose (CMC), a polyacrylic acid-based binder, a poly(3,4-ethylenedioxythiophene) (PEDOT)-based binder, and the like may be used as a negative electrode binder.

### [Separator]

A separator may be interposed between the positive electrode and the negative electrode. The separator may be formed so that electrical short circuit between the positive electrode and the negative electrode is prevented and an ion flow occurs. According to an exemplary embodiment, the thickness of the separator may be 10 μm to 20 μm, but the present disclosure is not limited thereto.

For example, the separator may include a porous polymer film or a porous non-woven fabric. The porous polymer film may include a polyolefin-based polymer such as an ethylene polymer, a propylene polymer, an ethylene/butene copolymer, an ethylene/hexene copolymer, and an ethylene/methacrylate copolymer. The porous non-woven fabric may include high-melting point glass fiber, polyethylene terephthalate fiber, and the like. The separator may include ceramic-based materials. For example, inorganic particles may be coated on the polymer film or dispersed in the polymer film to improve heat resistance.

The separator may have a single layer or multilayer structure including the polymer film and/or the non-woven fabric described above.

### [Electrode Assembly]

According to exemplary embodiments, the positive electrode, the negative electrode, and the separator may be repeatedly disposed to form an electrode assembly. In some exemplary embodiments, the electrode assembly may be a winding type, a stacking type, a zigzag (z)-folding type, or a stack-folding type.

### [Electrolyte]

A lithium secondary battery may be defined by housing the electrode assembly in a case with an electrolyte. According to exemplary embodiments, a nonaqueous electrolytic solution may be used as the electrolyte.

### (Lithium Salt/Organic Solvent)

A nonaqueous electrolyte solution includes a lithium salt as an electrolyte and an organic solvent, the lithium salt is represented by, for example, Li⁺X⁻, and an example of an anion (X⁻) of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, and the like.

The organic solvent has sufficient solubility of the lithium salt or the additive, and may include an organic compound having no reactivity in a battery. The organic solvent may include, for example, at least one of carbonate-based solvents, ester-based solvents, ether-based solvents, ketone-based solvents, alcohol-based solvents, and aprotic solvents. An example of the organic solvent may include propylene carbonate (PC), ethylene carbonate (EC), butylene carbonate, diethyl carbonate (DEC), dimethyl carbonate (DMC), ethyl methyl carbonate (EMC), methyl propyl carbonate, ethyl propyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF) and 2-methyltetrahydrofuran, ethyl alcohol, isopropyl alcohol, dimethylsulfoxide, acetonitrile, dimethoxyethane, sulfolane, Y-butyrolactone, propylene sulfite, and the like. These may be used alone or in combination of two or more.

### (Additive)

The nonaqueous electrolytic solution may further include an additive. The additive may include, for example, cyclic carbonate-based compounds, fluorine-substituted carbonate-based compounds, sultone-based compounds, cyclic sulfate-based compounds, cyclic sulfite-based compounds, phosphate-based compounds, and borate-based compounds. The cyclic carbonate-based compound may include

vinylene carbonate (VC), vinylethylene carbonate (VEC), or the like.

The fluorine-substituted cyclic carbonate-based compound may include fluoroethylene carbonate (FEC) and the like.

The sultone-based compound may include 1,3-propane sultone, 1,3-propene sultone, 1,4-butane sultone, and the like.

The cyclic sulfate-based compound may include 1,2-ethylene sulfate, 1,2-propylene sulfate, and the like.

The cyclic sulfite-based compound may include ethylene sulfite, butylene sulfite, and the like.

The phosphate-based compound may include lithium difluoro bis-oxalato phosphate, lithium difluoro phosphate, and the like.

The borate-based compound may include lithium bis(oxalate) borate and the like.

### [Cell Structure]

For example, electrode tabs (positive electrode tab and negative electrode tab) may protrude from the positive electrode current collector and the negative electrode current collector and extend to one side of a case, respectively. The electrode tabs may be connected to electrode leads (positive electrode lead and negative electrode lead) which are fused with the one side of the case and extended or exposed to the outside of the case. For example, a pouch-type case, an angular case, a cylindrical case, a coin-type case, and the like may be used.

Hereinafter, the examples will be further described with reference to the specific experimental examples. It is apparent to those skilled in the art that the examples and the comparative examples included in the experimental examples only illustrate an exemplary embodiment and do not limit the appended claims, and various modifications and alterations of the examples may be made within the range of the scope and spirit of the present disclosure, and these modifications and alterations will fall within the appended claims.

### <Test Method>

1. Measurement of Electrode Loading Amount (Unit: mg/cm²)

The loading amount of an electrode was calculated as solid content mass (mg) of a slurry for forming an electrode mixture layer per unit area (cm²) of the electrode. Specifically, after manufacturing the electrode, the electrode was punched at 80Ø (50.27 cm²), and then calculation of 80Ø electrode mass−80Ø Cu foil mass was performed. The mass was divided by 80Ø to calculate the loading amount.

2. Measurement of Electrode Specific Surface Area (Unit: m²/g)

The specific surface area of an electrode was measured using a Macsorb HM Model-1208 model available from MOUNTECH and a measurement program, Automatic Surface Area Analyzer Macsorb.

3. Inductively-Coupled Plasma (ICP) Emission Spectrometry (Unit: ppm)

Inductively-coupled plasma emission spectrometry was performed using a 720 ICP-OES model available from Agilent. Specifically, an electrode was collected with a round part of a 1 mL pipette tip, 0.15 g of a sample was taken in a vial, hydrochloric acid and hydrogen peroxide were added, and dissolution with heating was performed. The sample was cooled to room temperature and diluted with 40 mL of ultrapure water, and when an insoluble carbon component remained, it was removed with a 0.45 μm syringe filter, and analysis was performed using an instrument.

### 4. Analysis of Whether Electrode Cracks Occurred

By visual analysis, when not a single crack occurred and there was no folding, it was evaluated as “No cracks (x)”, and if not, it was evaluated as “crack occurrence (◯)”.

### 5. Analysis of Electrode Adhesive Strength

Electrode adhesive strength was measured using a VR300S model available from Hwain Automation. A tape for measuring adhesive strength was placed on an electrode, a roller having a load of 2 kg was traveled back and forth 10 times, and then the tape adhered on the electrode was precisely cut to have a width of 18 mm. The electrode was attached to the center of a jig having a double-sided tape attached thereto so that the cut tape side of the electrode faced down, and then a force (peel strength) when the electrode coating film (copper thin film) was completely separated from the tape side was measured.

### 6. Measurement of Coin Cell Lifespan (Unit: %)

A lithium coin half-cell manufactured in the example was cycled 100 times under the life conditions of 0.3 CC-CV charge/0.5 C discharge, and then (100 cycle discharge amount/1 cycle discharge amount)×100 was expressed as a lifespan.

### Example 1

Manufacture of negative electrode: Al(NO₃)₃ was dissolved in and diluted with a solvent (distilled water) to prepare a solution for forming a shell. Next, the solution for forming a shell was added to 20 g of graphite particles in which artificial graphite (D50: 14 μm) and natural graphite (D50: 12 μm) were mixed at a weight ratio of 5:5, and at this time, the weight ratio between the graphite particles and Al(NO₃)₃ was 99.95:0.05. They were mixed so that the solid content was 70 wt %, and then mixing was performed with a mixer for 30 minutes. A vacuum line was connected to the mixer to perform vacuum drying for 24 hours or more until the mixture was completely dried, thereby preparing core-shell particles.

Next, the core-shell particles, an SBR binder (BM451B available from Zeon), and a CMC thickener (D2200 available from Daicel) were added to distilled water as a solvent at a weight ratio of 97.6:1.2:1.2, thereby preparing a slurry for forming a negative electrode mixture layer. The prepared slurry was applied on a copper (Cu) thin film having a thickness of 8 μm, dried at 120° C., and roll-pressed to manufacture a negative electrode having a thickness of 120 μm and an electrode width of 300 mm.

Manufacture of battery: A lithium metal was used as a counter electrode of the negative electrode, and a separator (polyethylene, thickness: 20 μm) was interposed therebetween to form a lithium coin half-cell. A combination of lithium metal/separator/negative electrode was added to a coin cell plate, an electrolytic solution was injected, and it was covered with a cap and clamped. As the electrolytic solution, an electrolytic solution obtained by dissolving 1.0 M LiPF₆ in a mixed solvent of EC/EMC(volume ratio of 3:7), and then adding 2.0 vol % of FEC to the total volume of the electrolytic solution was used. After clamping, impregnation was performed for 3 to 24 hours, and then 3 cycles of charge/discharge were performed at 0.1 C (charge condition: CC-CV 0.1 C 0.01V 0.01 C CUT-OFF, discharge condition: CC 0.1 C 1.5V CUT-OFF).

### Examples 2 to 25

The core-shell particles and the batteries according to Examples 2 to 25 were manufactured in the same manner as in Example 1, except that the composition of the core-shell particles, the electrode loading amount, the electrode specific surface area, and ICP data were as shown in the following Table 1:

TABLE 1

| | | | Loading | Electrode | ICP |
|---|---|---|---|---|---|
| | | Shell (^{A)} | amount | specific | (Al, |
| Example | Core (weight ratio) | wt %) | (mg/ cm²) | area (m²/g) | ppm) |
| 1 | Artificial graphite/ | Al (NO₃)₃ | 15 | 2.19 | 16.30 |
| | natural graphite | (0.05 wt %) | | | |
| | (5/5) | | | | |
| 2 | Artificial graphite/ | Al (NO₃)₃ | 15 | 2.08 | 75.2 |
| | natural graphite | (0.1 wt %) | | | |
| | (5/5) | | | | |
| 3 | Artificial graphite/ | Al (NO₃)₃ | 15 | 1.89 | 154.2 |
| | natural graphite | (0.2 wt %) | | | |
| | (5/5) | | | | |
| 4 | Artificial graphite/ | Al (NO₃)₃ | 15 | 1.69 | 801.4 |
| | natural graphite | (1.0 wt %) | | | |
| | (5/5) | | | | |
| 5 | Artificial graphite/ | Al (NO₃)₃ | 15 | 1.26 | 2025.0 |
| | natural graphite | (3.0 wt %) | | | |
| | (5/5) | | | | |
| 6 | Artificial graphite/ | Al (NO₃)₃ | 15 | 1.92 | 21.10 |
| | natural graphite | (0.05 wt %) | | | |
| | (7/3) | | | | |
| 7 | Artificial graphite/ | Al (NO₃)₃ | 15 | 1.80 | 71.5 |
| | natural graphite | (0.1 wt %) | | | |
| | (7/3) | | | | |
| 8 | Artificial graphite/ | Al (NO₃)₃ | 15 | 1.70 | 167.1 |
| | natural graphite | (0.2 wt %) | | | |
| | (7/3) | | | | |
| 9 | Artificial graphite/ | Al (NO₃)₃ | 15 | 1.45 | 972.1 |
| | natural graphite | (1.0 wt %) | | | |
| | (7/3) | | | | |
| 10 | Artificial graphite/ | Al (NO₃)₃ | 15 | 0.98 | 2248.0 |
| | natural graphite | (3.0 wt %) | | | |
| | (7/3) | | | | |
| 11 | Artificial graphite/ | Al (OH)₃ | 15 | 1.89 | 704.2 |
| | natural graphite | (0.2 wt %) | | | |
| | (5/5) | | | | |
| 12 | Artificial graphite/ | Al₂ (SO₄)₃ | 15 | 1.76 | 128.5 |
| | natural graphite | (0.2 wt %) | | | |
| | (5/5) | | | | |
| 13 | Artificial graphite | Al (NO₃)₃ | 15 | 1.68 | 17.25 |
| | | (0.05 wt %) | | | |
| 14 | Artificial graphite | Al (NO₃)₃ | 15 | 1.60 | 67.2 |
| | | (0.1 wt %) | | | |
| 15 | Artificial graphite | Al (NO₃)₃ | 15 | 1.51 | 180.6 |
| | | (0.2 wt %) | | | |
| 16 | Artificial graphite | Al (NO₃)₃ | 15 | 1.35 | 783.5 |
| | | (1.0 wt %) | | | |
| 17 | Artificial graphite | Al (NO₃)₃ | 15 | 0.75 | 3574.0 |
| | | (3.0 wt %) | | | |
| 18 | Artificial graphite | Al (NO₃)₃ | 17 | 1.59 | 67.2 |
| | | (0.1 wt %) | | | |
| 19 | Artificial graphite | Al (NO₃)₃ | 17 | 1.51 | 180.6 |
| | | (0.2 wt %) | | | |
| 20 | Artificial graphite | Al (NO₃)₃ | 17 | 1.36 | 745.4 |
| | | (1.0 wt %) | | | |
| 21 | Artificial graphite | Al (NO₃)₃ | 17 | 0.66 | 2788.0 |
| | | (3.0 wt %) | | | |
| 22 | Artificial graphite | Al (NO₃)₃ | 19 | 1.60 | 67.2 |
| | | (0.1 wt %) | | | |
| 23 | Artificial graphite | Al (NO₃)₃ | 19 | 1.52 | 180.6 |
| | | (0.2 wt %) | | | |
| 24 | Artificial graphite | Al (NO₃)₃ | 19 | 1.14 | 798.0 |
| | | (1.0 wt %) | | | |
| 25 | Artificial graphite | Al (NO₃)₃ | 19 | 0.70 | 2422.0 |
| | | (3.0 wt %) | | | |

(^{A)} The “wt %” is the wt % of the metal salt included in the shell, based on the total weight of the graphite particles included in the core and the metal salt included in the shell.)

### Comparative Example 1

A battery was manufactured in the same manner as in Example 1, except that the negative electrode was manufactured as follows.

Manufacture of negative electrode: Graphite particles in which artificial graphite (D50: 14 μm) and natural graphite (D50: 12 μm) were mixed at a weight ratio of 5:5, an SBR binder (BM451B available from Zeon), and a CMC thickener (D2200 available from Daicel) were added to distilled water as a solvent at a weight ratio of 97.6:1.2:1.2, thereby preparing a slurry for forming a negative electrode mixture layer. The prepared slurry was applied on a copper (Cu) thin film having a thickness of 8 μm, dried at 120° C., and roll-pressed to manufacture a negative electrode having a thickness of 120 μm and an electrode width of 300 mm.

### Comparative Examples 2 to 5

The core particles and the batteries according to Comparative Examples 2 to 5 were manufactured in the same manner as in Comparative Example 1, except that the composition of the core particles, the electrode loading amount, and the electrode specific surface area were as shown in the following Table 2.

TABLE 2

| | | | Loading | Electrode | |
|---|---|---|---|---|---|
| Comparative | Core (weight | Shell | amount | specific | ICP (Al, |
| Example | ratio) | (wt %) | (mg/cm²) | area (m²/g) | ppm) |
| 1 | Artificial | — | 15 | 2.23 | — |
| | graphite/natural | | | | |
| | graphite | | | | |
| | (5/5) | | | | |
| 2 | Artificial | — | 15 | 1.99 | — |
| | graphite/natural | | | | |
| | graphite | | | | |
| | (7/3) | | | | |
| 3 | Artificial | — | 15 | 1.72 | — |
| | graphite | | | | |
| 4 | Artificial | — | 17 | 1.72 | — |
| | graphite | | | | |
| 5 | Artificial | — | 19 | 1.70 | — |
| | graphite | | | | |

The electrode adhesive strength, crack occurrence on the electrode, and the lifespan of the coin cell were analyzed according to the above test method, using the electrodes manufactured in the examples and the comparative examples, and the results are shown in the following Table 3.

TABLE 3

| | | | Coin cell lifespan |
|---|---|---|---|
| | Adhesive | Occurrence of | (%, 0.3 C/0.5 C, |
| Example | strength (N) | electrode cracks | 100 cycles) |
| 1 | 0.54 | x | 87.2 |
| 2 | 0.65 | x | 88.4 |
| 3 | 0.77 | x | 90.4 |
| 4 | 0.83 | x | 72.1 |
| 5 | 1.23 | x | 64.9 |
| 6 | 0.52 | x | 86.4 |
| 7 | 0.63 | x | 88.0 |
| 8 | 0.73 | x | 91.4 |
| 9 | 0.83 | x | 74.1 |
| 10 | 1.12 | x | 61.4 |
| 11 | 0.81 | x | 87.1 |
| 12 | 0.75 | x | 89.1 |
| 13 | 0.52 | x | 82.1 |
| 14 | 0.68 | x | 87.2 |
| 15 | 0.78 | x | 94.8 |
| 16 | 0.81 | x | 81.5 |
| 17 | 1.04 | x | 68.1 |
| 18 | 0.57 | x | 67.1 |
| 19 | 0.65 | x | 80.8 |
| 20 | 0.78 | x | 84.6 |
| 21 | 0.89 | x | 69.2 |
| 22 | 0.54 | x | 64.1 |
| 23 | 0.68 | x | 75.0 |
| 24 | 0.73 | x | 82.5 |
| 25 | 0.87 | x | 67.1 |

TABLE 4

| Comparative | Adhesive | Occurrence of | Coin cell lifespan (%, |
|---|---|---|---|
| Example | strength (N) | electrode cracks | 0.3 C/0.5 C, 100 cycles) |
| 1 | 0.36 | ∘ | 52.7 |
| 2 | 0.33 | ∘ | 54.9 |
| 3 | 0.26 | ∘ | 45.1 |
| 4 | 0.21 | ∘ | 42.3 |
| 5 | 0.19 | ∘ | 32.8 |

As confirmed from Tables 3 and 4, when the electrode was manufactured using the active material having a core-shell structure in which the surface of carbonaceous particles was coated with a metal salt as in the examples, cracks did not occur after drying the electrode even when the electrode loading amount was increased to about 15 mg/cm² or more due to the strengthened binding strength between the active material having a core-shell structure and a binder (SBR). Furthermore, in the above examples, the adhesive strength between the electrode mixture layer and the current collector was significantly higher than that of the comparative examples including only the carbonaceous particles having an uncoated surface as the active material, and a high-quality electrode having a long lifespan was able to be manufactured.

According to an exemplary embodiment of the present disclosure, the binding strength between an electrode active material and a binder may be strengthened, and also an electrode may be effectively manufactured without occurrence of cracks even with high loading of the electrode.

The above description is only an example to which the principle of the present disclosure is applied, and other constitutions may be further included without departing from the scope of the present disclosure. Hereinabove, though an implementation has been described in detail by the examples and the experimental examples, the scope of an implementation is not limited to specific examples, and should be construed by the appended claims.

What is claimed is:

1. An electrode active material comprising core-shell particles comprising: a core comprising carbonaceous particles; and a shell surrounding at least a part of a surface of the core,
wherein the shell comprises a metal salt.

2. The electrode active material of claim 1, wherein the metal salt is comprised at 5.0 wt % or less with respect to the total weight of the carbonaceous particles and the metal salt.

3. The electrode active material of claim 1, wherein a content of a metal element in the metal salt measured by an inductively-coupled plasma (ICP) emission spectrometer is 10 ppm to 5,000 ppm.

4. The electrode active material of claim 1, wherein the carbonaceous particles comprise any one or more selected from the group consisting of artificial graphite, natural graphite, soft carbon, carbon black, acetylene black, ketjen black, carbon fiber, and mesocarbon microbeads (MCMB).

5. The electrode active material of claim 1, wherein the carbonaceous particles comprise any one or more of artificial graphite and natural graphite.

6. The electrode active material of claim 1, wherein the metal salt comprise any one or more selected from the group consisting of an aluminum salt, a lithium salt, a lanthanum salt, a sodium salt, a potassium salt, a calcium salt, a magnesium salt, a copper salt, a silver salt, a gold salt, a zinc salt, a platinum salt, a nickel salt, an iron salt, a tin salt, a lead salt, a cobalt salt, a chromium salt, a molybdenum salt, a vanadium salt, a thallium salt, and a niobium salt.

7. A slurry for forming an electrode mixture layer comprising the electrode active material of claim 1.

8. The slurry for forming an electrode mixture layer of claim 7, further comprising a binder.

9. The slurry for forming an electrode mixture layer of claim 7, further comprising any one or more of a conductive material, a thickener, and a dispersant.

10. An electrode comprising:
a current collector; and
an electrode mixture layer which is placed on the current collector and is formed from the slurry for forming an electrode mixture layer of claim 9.

11. The electrode of claim 10, wherein the electrode mixture layer comprises a binder, and the binder is comprised at 0.5 wt % to 5.0 wt % based on the total weight of the electrode mixture layer.

12. An electrochemical device comprising the electrode of claim 10.

13. An electrode comprising:
a current collector; and
an electrode mixture layer placed on the current collector,
wherein the electrode has a coating width of 200 mm or more and a loading amount of 12 mg/cm² or more, and
adhesive strength between the current collector and the electrode mixture layer is 0.3 N or more.

14. An electrochemical device comprising the electrode of claim 13.
